(19) United States
(12) Patent Application Publication
(10) Pub. No.: US 2014/0220225 A1
(43) Pub. Date: Aug. 7, 2014

(54) High protein whipped collet extrusion crunchy snack product and manufacturing apparatus and process

(71) Applicant: Ray M. Alden, Raleigh, NC (US)

(72) Inventor: Ray M. Alden, Raleigh, NC (US)

(21) Appl. No.: 13/999,015

(22) Filed: Jan. 2, 2014

Related U.S. Application Data
(63) Continuation-in-part of application No. 13/986,839, filed on Jun. 10, 2013.
Application No. 13/986,839 is a continuation-in-part of application No. 13/573,242, filed on Sep. 4, 2012.

(51) Int. Cl. A23L 1/32

(52) U.S. Cl. CPC A23L 1/3212
USPC 426/614

(57) ABSTRACT

The invention described herein comprises a crunchy egg product, formulae, manufacturing apparatus, and manufacturing processes to produce a desirable consumer product that is nutritious and fulfills a gap in crunchy low carbohydrate snack food product category. The final product comprises a crunchy whipped egg collet having a low water content by weight, audible fracturing characteristics, and brittleness flex and stress characteristics. It comprises a low carbohydrate, high protein crunchy snack food for consumption by those on a low carbohydrate diet.

### RELATED APPLICATIONS

This patent application is a Continuation In Part of U.S. patent application Ser. No. 13/573,242 filed Sep. 4, 2012, U.S. patent application Ser. No. 13/986,839 filed Jun. 10, 2013, and of U.S. patent application Ser. No. 13/987,751 filed Aug. 28, 2013.

### BACKGROUND FIELD OF INVENTION

This invention relates to a food product manufactured for human or animal consumption. More specifically a crunchy, high protein, low carbohydrate product that utilizes egg as a primary ingredient is described. The product, formula, manufacturing apparatus, and manufacturing process are also described.

### BACKGROUND-DESCRIPTION OF PRIOR INVENTION

Since before recorded history, humans have consumed eggs as a food. For thousands of years, eggs have been utilized as an important ingredient in thousands of food recipes. As an ingredient, eggs are often mixed into a batter with other ingredients. For example to make hundreds of types of baked goods including breads, cakes, cookies, and crackers, a grain such as wheat is used as a primary ingredient, eggs are mixed in to achieve properties such as cohesiveness, texture, and appearance while salt or sugar are added for taste. More recently United States Patent Application 2013/0022731, Olson disclosed a baked or fried crunchy snack food product that mixes a grain starch such as rice flour and egg to produce a snack food product having a protein to carbohydrate mass ratio of roughly 1 to 1. Also U.S. Pat. No. 7,939,123 Tillis, and U.S. Pat. No. 7,943,191 Tillis describe egg based French Fries with a crispy exterior and with water content between 15% and 25%.

In modern day western civilization, much cost and effort is expended by people trying to lose weight or to remain trim. One very common approach is to eat a diet significantly restricted in carbohydrates such as sugars, grains, rice, corn, starches, chick pea flour, and grain flours. To replace these foods, people on carbohydrate restricted diets typically substitute in more protein and fat than what is considered a traditional diet but these people can and do loose significant weight. Once a consumer starts a low carbohydrate diet, it quickly becomes apparent to them that few crunchy types of low carbohydrate snack foods are available in a conveniently packaged product. Pork rinds being the only widely available high protein, low carbohydrate, bagged crunchy chip like snack food. Many products in the salty snack crunchy food category call themselves “high protein” and “low carbohydrate” but actually typically have a protein to carbohydrate mass ratio of roughly 1 to 1 or less. Crunchy snack foods that have very low carbohydrate content are needed.

Typical crunchy snack foods such as potato chips, corn chips, pretzels, crackers, and cookies all comprise low protein and high carbohydrates or sugars and generally having a protein to carb ratio less than 0.5 to 1. Thus people whom are on carbohydrate restricted diets very much miss snacking on many crunchy snack food choices. As described herein, crunchy snack foods made using eggs and with no added corn meal, grain, starch, or flour is a good substitute for crunchy snack foods made from carbohydrates such as corn, rice, grain, flour, starches, and sugars.

Corn meal collets commonly known as “cheese puffs” are widely available to consumers from multiple manufacturers. They are often manufactured by extruding a corn meal water paste under heat and pressure which when released produces a vastly expanded very low density porous solid called a collet. The collet is then sprayed with one or more of oil, water, cheese, salt, orange dye to achieve desired texture, color, and flavor and then can be passed through a heated dryer to optimize crispness and minimize water content. The finished product is low moisture (below 10%), exceptionally crunchy, salty, and flavorful but is also low in protein and high in carbohydrates for example having a protein to carb ratio of 0.2 to 1. The term collet is adopted in the below specifications to describe the puffed whipped egg extrusion of the present invention but it should be noted that the process utilized herein begins with whipping an egg to an aerated state which is a contrast to the pressure based extrusion process to produce a collet in the prior art as above.

### BRIEF SUMMARY

The present invention comprises the ingredients, formulae, apparatus, and manufacturing process required to manufacture a crunchy snack food that has low moisture, is exceptionally crunchy, high in protein, low in carbohydrates, and has the low density, texture, and flavor similar to a corn meal based collet (cheese puff). By weight the final crunchy egg product resembles “cheese puffs” but contains a protein to carbohydrate ratio much higher for example 16.15 parts protein to 1 part carbohydrate. The crunchy texture is described in terms of having a low moisture or water content, an audible “crack” sound when fractured, and a brittleness as demonstrated in fracture when subjected to even a low angular bend in a Three Point Bend test. In this test “fracture” is defined as the external wall of the product crushing with crunch attributes such as a sound or sudden break due to brittleness when pressure is applied. Alternately in this test “fracture” is defined as the product cracking into two parts with crunch attributes such as a sound or sudden break due to brittleness when pressure is applied. During product consumption, the brittleness and sound comprise dimensions known to consumers as “crunchy”. Further the product can be gluten free, lactose free, peanut free, organic, non-gmo, and Kosher.

### Objects and Advantages

Accordingly, several objects and advantages of the present invention are apparent. The present invention utilizes eggs as a primary ingredient. Eggs are a well known and accepted form of protein easily metabolized in the human body. The final product may comprise egg solids between 5% and 95% by volume. Additional protein sources can be added to the egg ingredient to boost the protein to carb ratio. Solids in the final product may comprise a protein to carbohydrate around 16.15 (or greater) parts protein to 1 part carbohydrate (when liquid egg whites are used and additional high protein ingredients are added). Alternately, the final product may comprise a protein to carbohydrate ratio around 7.5 parts protein to 1 part carbohydrate (when only liquid egg whites are used with no other added solid ingredients). A solid structure resembling a collet is achieved through a process of whipping an egg ingredient to achieve an airy structure and then cooking and removing water from the structure resulting in a crunchy, low density, airy product resembling a collet. Agricultural infrastructure makes eggs readily available in large quantities suitable as a high volume food source. Egg solids prepared and cooked as described herein form a low moisture crunchy product suitable for packaging and distribution as a long shelf life snack product. A large segment of the population is on a carbohydrate restricted diet and looking for products not containing sugar, flour, grains, rice, corn, or starch ingredients while still having the attributes of common snack foods including crunchy texture, fracturing brittleness, fracturing sound, product cohesiveness, familiar mouth feel and breakdown during chewing, customary tastes such as salt, cheese, and onion, long shelf life, and hand or mouth sized dimensions suitable for eating with one hand while driving or on the sofa without any fuss or mess. Also the optimal high protein product herein includes no sugars, grain, flours, corn, rice, or starch ingredients.

Further objects and advantages will become apparent from the enclosed figures and specifications.

### DRAWING FIGURES

FIG. 1 illustrates steps or modules in a manufacturing process to produce crunchy whipped egg products of the present invention.

FIG. 2a illustrates an oiling the cookware step.

FIG. 2b illustrates a deposition of whipped raw egg batter step.

FIG. 2c illustrates a spray additive step.

FIG. 3a illustrates an onion ring shaping mold.

FIG. 3b illustrates a high protein crunchy onion ring.

FIG. 3c illustrates an alternate high protein crunchy product shape.

FIG. 3d illustrates a final elongated whipped egg cullet product ready to eat.

FIG. 3e illustrates a dot shaped whipped egg cullet product ready to eat.

FIG. 3f illustrates a curly shaped whipped egg cullet product ready to eat.

FIG. 4a illustrates a whipped egg extrusion and cooking process where the batter begins cooking before deposition onto a cooking surface.

FIG. 4b illustrates a batter sheeting, cooking, and cutting process to produce whipped egg crunchy snack products.

### DETAILED DESCRIPTION OF THE INVENTION

This patent application is a Continuation In Part of U.S. patent application Ser. No. 13/573,242 filed Sep. 4, 2012, U.S. patent application Ser. No. 13/986,839 filed Jun. 10, 2013, and of U.S. patent application Ser. No. 13/987,751 filed Aug. 28, 2013, each of which are incorporated in full herein by reference (but not reprinted herein to avoid redundancy).

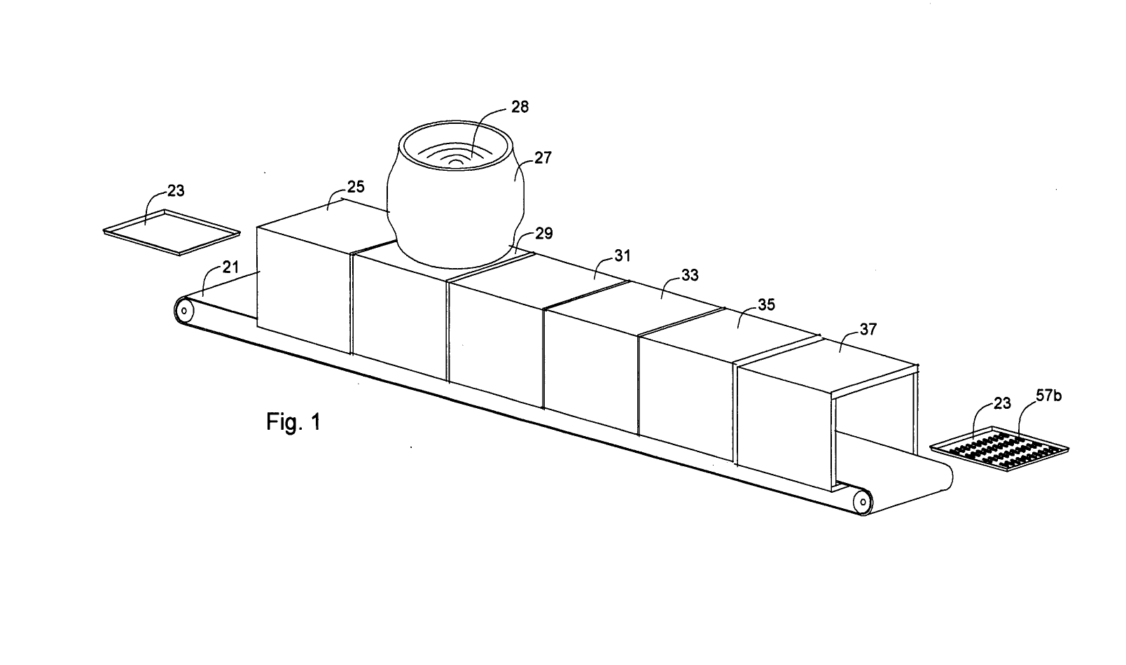

FIG. 1 illustrates modules or steps in a manufacturing process to produce whipped collet crunchy egg products of the present invention. A conveyor belt apparatus 21 drives product through manufacturing steps wherein on one end of the conveyor belt apparatus a cookware 23 is put in. The conveyor belt being suitable for use in a tunnel microwave oven (or tunnel RF oven) and in a tunnel convectional oven such as are available from commercial food manufacturing equipment suppliers listed in the Thomas Register of Manufacturers. The cookware being suitable for microwave use, RF oven use, baking use, and capable of withstanding the rigors of a continuous manufacturing process. The cookware can take the form of discrete cooking plate type elements as illustrated herein or wherein the surface of the conveyor belt is itself the cookware. During the manufacturing process, the cookware 23 advances on the conveyor belt apparatus 21 through a series of steps within manufacturing modules each engineered to perform a manufacturing process step. In the illustration each module is depicted as being approximately the same size however in practice, the respective module lengths and dimensions vary depending upon what process step is being performed and how much time a respective manufacturing process step takes. Each of the modules described are readily available from multiple suppliers specializing in industrial engineering systems for food cooking and preparation.

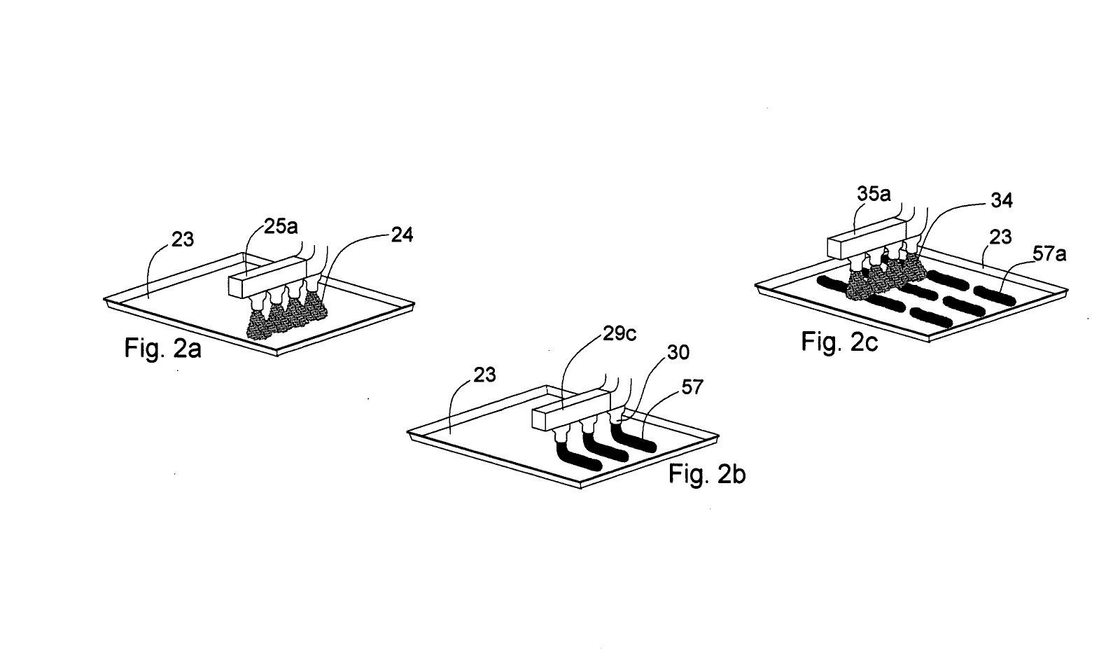

The first process step is performed on the cookware 23 itself in an oil deposition module 25 where the cooking surface is oiled as is further described and illustrated in FIG. 2a.

The second process step is an ingredient mixing module 27 step. Commercial grade food mixers are well known and readily available. For a crunchy puffed extrusion product of FIGS. 2b and 2c, ingredients are put into the ingredient mixing module in the proportions (scaled up to the size of the manufacturing operation) and processed as indicated below under paragraphs describing “A. Egg Puff”, “B. Egg Puff Plus Protein”, “C. Egg Puff Plus Protein Plus Cheese”, and “D. Egg Puff Plus Protein Plus Cheese Plus Oil” respectively.

Within the ingredient mixing module 27 the liquid egg white is first whipped to a quasi solid or peaking state and ingredients are mixed in through an automated stirring activity to form a raw egg batter 28 that has a consistency suitable for pressurized flow or pumping or deposition or extrusion as described subsequently herein. The egg is whipped until peaking into a heavily aerated quasi solid wherein no liquid remains in the batch. The gelatin ingredient can be added to the liquid egg white ingredient prior to whipping, if the liquid is maintained at a temperature around 110° F. that is suitable for the gelatin to melt into the liquid while the liquid egg white doesn't begin to coagulate. Within the raw egg ingredient deposition module 29 the raw egg batter is deposited onto the cookware 23 as illustrated and described in FIG. 2b. The deposition process is extrusion wherein raw egg batter is placed into a hopper and forced under low pressure out of extrusion nozzles onto the cooking surface. Once the cookware 23 has received its intended amount of raw egg batter it advances to a convection oven baking module 31 step where heat both cooks and removes water from the batter which after baking is a golden brown solid that is dry on the outside. Nearly all of the moisture is removed during baking and crunchy aerated low density collet like puffs result. Tunnel convection ovens for commercial food manufacturing are available from multiple suppliers. The baked collet puffs exit the baking module and if moisture remains on the interior, advances to a microwave oven (or RF oven) module 33 step where water molecules remaining within the baked product are heated and driven out of the product interior. During microwaving, the product shrinks around 20% to be a density similar to Cheetos and similar puffed corn meal brands. The cookware 23 advances to an ingredient additive module 35 step illustrated and described in FIG. 2c where additional ingredients are deposited onto the surface of the crunchy whipped collet work in progress. During the additive step, an orange colored cheese and salt slurry is sprayed onto the whipped collet. Oil can also be sprayed on to the collet in this spray additive step. Also, ideally the collets are deposited into a tumbler (not shown) and tumbled while being sprayed such that an even amount of additive ingredient is dispersed on all sides of each whipped collet. A tumbler is a stainless steel apparatus laid horizontally which rotates around its cylindrical axis such that collets placed into it are caused to rotate approximately around their cylindrical axis to receive sprayed on ingredients or powdered ingredients evenly around their exterior. The cookware 23 advances to a crisping module 37 step where a final oven (either conventional or microwave) removes additional moisture and further crispens the exterior. After moving through the modules and manufacturing process steps therein, a crunchy whipped collet egg product output 39 is forthcoming on the cookware 23.

It should be noted that the three ovens described above can be replaced by two ovens or a single oven step to achieve the desired moisture removal and cooking. Products have been produced using only microwaving and also using only convention oven baking but a mix of the two processes produces efficient and optimal results.

Following is a partial list of ingredients that have been utilized in differing proportions to produce crunchy whipped collet egg products similar to those described herein; whole egg, egg white, dried egg, dried egg white, egg white protein, water, onion, garlic, salt, pepper, cheese, yellow dye, orange dye, taco flavoring, barbecue flavoring, milk, dried buttermilk, whey protein, gelatin, dietary fiber, and oil. Many other ingredients are possible as additives to whipped egg whites to achieve collets of differencing protein levels, dietary fiber, colors, shapes, and flavors.

The following proportions and processes where utilized in a test kitchen to produce whipped egg collets and crunchy aerated products similar to corn meal based collets or cheese puffs but having many times higher protein to carbohydrate ratios.

For product “A. Egg Puff”, 10 tablespoons of liquid egg white are whipped with a mechanical whisk until they are fully whipped into a peaking quasi solid state. In the test kitchen a KitchenAid mixer on high setting will reliably achieve this in less than 5 minutes. The resulting solid is scooped into a one gallon zip-lock food storage bag approximately filling the bag to capacity. A 1 inch corner is cut off of the bag such that squeezing the bag causes the whipped egg to be extruded onto an oiled baking pan. Using this extrusion process in the test kitchen, multiple columns of whipped egg batter are extruded onto the oiled pan to resemble the illustration in FIG. 2b. The pan is placed into a convection oven and cooked at 325′ for 10 minutes. The extrusions generally maintain their shape through this process and exit the oven dry on the outside. Inside the partially cooked extrusions, moisture still exists. Eating the partially cooked extrusions at this point has a mouth feel similar to a cotton candy, the structures appear to be solid but when bitten easily collapse with very little resistance and little crunchy or brittle aspects since the interior moisture has prevented rigid structures from being produced within the interior. To facilitate moisture extraction from the interior more efficiently the extrusions are microwaved for 1 minute to 2 minutes (alternately a tunnel RF oven may be utilized). Note that, longer times in the convection baking oven at lower temperature can be substituted for microwaving. The extrusions will come from the microwave shrunken some but still maintaining their cylindrical cheese puff extrusion shape. They are placed back in the convention oven and cooked at 325 for 5 to 10 minutes and then removed as “A. Puffed Egg” extrusions. The following table details the processes, steps, ingredients, and results for the A. Puffed Extrusions utilizing only egg whites as an ingredient together with an oiled pan. The resulting collet having a protein to carb ratio of approximately 7.5 to 1.

A. Puffed Egg

| | | |
|---|---|---|
| First | Liquid egg white | 10 tablespoons |
| Ingredient | | |
| Whip | Whip 5 minutes | whip until all liquid is transformed |
| | | into solid |
| Baking Sheet | canola oil spray | spray baking sheet with canola oil |
| Extrude | extrude | extrude whipped batter onto oiled |
| | | baking sheet |
| Bake | Convection oven | 325° 10 minutes |
| Microwave | Microwave oven | 1 to 2 minutes |
| Bake | Convection oven | 325° 10 minutes |
| Results | Color | golden brown |
| | Shape | long cylindrical low density porous |
| | | aerated crisps |
| | Solid | yes |
| | Crunchy | yes |
| | Mouth feel | crunchy, breaks apart nicely, similar |
| | | to corn meal puffs but more delicate |
| | taste | without flavor additives or oil has a |
| | | bland flavor |

For product “B. Puffed Egg Plus Protein”, 10 tablespoons of liquid egg white plus liquid gelatin are whipped with a mechanical whisk until they are fully whipped into a solid. The gelatin will liquefy in water above 110° F. and mix with the liquid egg at that temperature, 1 table spoon gelatin to 3 tablespoons water. In the test kitchen a KitchenAid mixer on high setting will reliably whip the egg white plus gelatin in less than 5 minutes. Gelatin having a protein to carb ratio of greater than 10 parts protein to 1 part carbohydrate comprising a high protein additive prior to whipping. After whipping additional protein ingredients are added to the whipped egg. To the whipped egg with gelatin quasi solid is added additional protein such as egg white protein, and/or whey protein that have been used individually or in combination to produce high protein collet extrusions that resemble corn meal based cheese puffs. The trick is to lightly mix these ingredients into the whipped egg so that they are mixed in but the whipped egg is not transformed back to a liquid. In the test kitchen, a KitchenAid mixer on slow achieves this in about 10 seconds. Note that the longer and more vigorously these ingredients are mixed with the whipped egg, the more the whipped egg is transformed from a quasi solid back to liquid (not desirable).

The resulting solid like foam is scooped into a food storage bag and a 1 inch corner cut off of the bag such that squeezing the bag causes the whipped egg to be extruded onto an oiled baking pan. Thus multiple strips are extruded onto the pan similar to the illustration in FIG. 2b. The pan is placed into a convention oven and cooked at 325° for 10 minutes. The extrusions generally maintain their shape through this process and are dry on the outside. Inside moisture still exists. To facilitate moisture extraction from the interior more efficiently the extrusions are microwaved for 1 to 2 minutes (alternately a tunnel RF oven may be utilized). Note, longer times in the baking oven at lower temperature can be substituted for microwaving or microwaving at longer times can be substituted for the convection oven. The extrusions will come from the microwave shrunken by approximately 20%. They are placed back in the convection oven and cooked at 325° for 10 minutes and then removed as “B. Puffed Egg plus Protein” extrusions. The following table details the processes, steps and ingredients for the B. Puffed Egg Extrusions plus Protein utilizing egg whites, gelatin, egg white protein, and whey protein as ingredients together with an oiled pan. The resulting collets comprise approximately 16.15 parts protein to 1 part carbohydrate.

B. Puffed Egg Plus Protein

| | | |
|---|---|---|
| First | Liquid egg white | 10 tablespoons at 100° F. |
| Ingredient | | |
| | Add Protein | 1 table spoon gelatin crystals melted |
| | ingredient | in 3 tablespoon warm water |
| Whip | Whip 5 minutes | whip until all liquid is transformed |
| | | into solid, whipped egg peaks |
| Add | Add Protein | 1 table spoon egg white protein powder |
| Ingredients | ingredient | |
| | Add Protein | 1 table spoon whey protein powder |
| | ingredient | |
| Whip | Whip 10 seconds | whip slowly and briefly until added |
| | | ingredients are mixed with whipped egg |
| Baking Sheet | canola oil spray | spray baking sheet with canola oil |
| Extrude | extrude | extrude whipped batter onto oiled |
| | | baking sheet |
| Bake | Convection oven | 325° 10 minutes |
| Microwave | Microwave oven | 1 to 2 minutes |
| Bake | Convection oven | 325° 10 minutes |
| Results | Color | golden brown |
| | Shape | long cylindrical low density porous |
| | | aerated crisps |
| | Solid | yes |
| | Crunchy | yes |
| | Mouth feel | crunchy, breaks apart nicely, similar |
| | | to corn meal puffs but more delicate |
| | taste | without flavor additives or oil has a |
| | | bland flavor |

The following table shows details regarding crunchy puffed protein products that were produced including; the above “A. Egg Puff” product, the above “B. Egg Puff plus protein” product, the below “C. Egg Puff plus protein plus cheese” product, and the below “D. Egg Puff plus protein plus cheese plus oil” product. Each of these products comprise a crunchy whipped egg collet 57b exiting the manufacturing process.

| | | | Jay Robb | Whey | | | | | TOTAL | | TOTAL |
|---|---|---|---|---|---|---|---|---|---|---|---|
| Solid Contents | | powdered | egg white | Factors | | | | | protein | TOTAL Egg | percent |
| of Puffed | | egg white | protein | whey | | TOTAL | TOTAL | TOTAL | volume per | Solids per | Egg Solids |
| Protein | liquid | (calculated | (tbl | Protein (tbl | gelatin | Units | Carb. | protein | carb | Non-Egg | per TOTAL |
| Extrusion | egg white | tbl spoon) | spoon) | spoon) | (tbl spoon) | Volume | Density | density | volume | Solids | Solids |
| Carbohydrate | | 0.10 | 0.04 | 0.06 | 0.01 | | | | | | |
| % by weight | | | | | | | | | | | |
| Protein % by | | 0.75 | 0.96 | 0.94 | 1.00 | | | | | | |
| weight | | | | | | | | | | | |
| A. Egg Puff | 10.00 | 1.30 | 0.00 | 0.00 | 0.00 | 1.30 | 0.10 | 0.75 | 7.50 | 1000 | 100% |
| B. Egg Puff | 10.00 | 1.30 | 1.00 | 1.00 | 1.00 | 4.30 | 0.06 | 0.90 | 16.15 | 1.15 | 53% |
| plus protein | | | | | | | | | | | |
| C. Egg Puff | 10.00 | 1.30 | 1.00 | 1.00 | 1.00 | 5.30 | 0.09 | 0.87 | 9.67 | 0.77 | 43% |
| plus protein | | | | | | | | | | | |
| plus cheese | | | | | | | | | | | |
| D. Egg Puff | 10.00 | 1.30 | 1.00 | 1.00 | 1.00 | 5.30 | 0.09 | 0.87 | 9.67 | 0.77 | 43% |
| plus protein | | | | | | | | | | | |
| plus cheese | | | | | | | | | | | |
| plus oil | | | | | | | | | | | |

The A. Egg Puff product has 7.5 volume units of protein for every 1 volume unit of carbohydrates and solids are 100% egg solids. The B. Egg Puff plus protein product has 16.15 volume units of protein for every 1 volume unit of carbohydrates and solids are 53% egg solids. We also produced cheese flavored “C. Egg Puff plus protein plus cheese” products using the identical processes and ingredients as in the B. Egg Puff plus protein product but during the ingredient additive step we also added 1 tablespoon of yellow cheese power comprising cheese and salt which we briefly and gently mixed during the ingredient addition step. The resulting “C. Egg Puff plus protein plus cheese” product has 9.67 volume units of protein for every 1 volume unit of carbohydrates and solids are 43% egg solids. We also produced cheese flavored “D. Egg Puff plus protein plus cheese plus oil” products using the identical processes and ingredients as in the C. Egg Puff plus protein plus cheese product but during the ingredient additive step we also sprayed into the whipped egg 1 tablespoon of canola oil spray. The resulting “D. Egg Puff plus protein plus cheese plus oil” product has 9.67 volume units of protein for every 1 volume unit of carbohydrates and solids are 43% egg solids. The A. B. C. and D. all comprising collets that are produced from first whipping egg white then cooking and removing moisture and resulting in a low density aerated crunchy product in traditional snack food hand sized or bite sized pieces very similar in appearance, taste, and mouth feel to collets commonly produced from prior art extruded corn meal processes which are widely available to consumers.

It should be noted that products produced using only liquid egg whites and a flavoring ingredient such as cheese were produced having a protein to carb ratio of approximately 3 volume units of protein for every 1 volume units of carbohydrate and 1.3 volume units of egg solids for 1 volume unit of non-egg solids. Alternate ratios are possible to achieve a wide range of ratios from 2 units or greater of protein to 1 unit of carbohydrates and/or with egg solids comprising less than 43%.

Each product begins with 10 tablespoons of liquid egg white being whipped to a peaked quasi solid. In fact as described herein, liquid egg white alone (with no other ingredients) whipped and cooked as specified herein transforms into a crunchy puffed product resembling a prior art corn meal based collet.

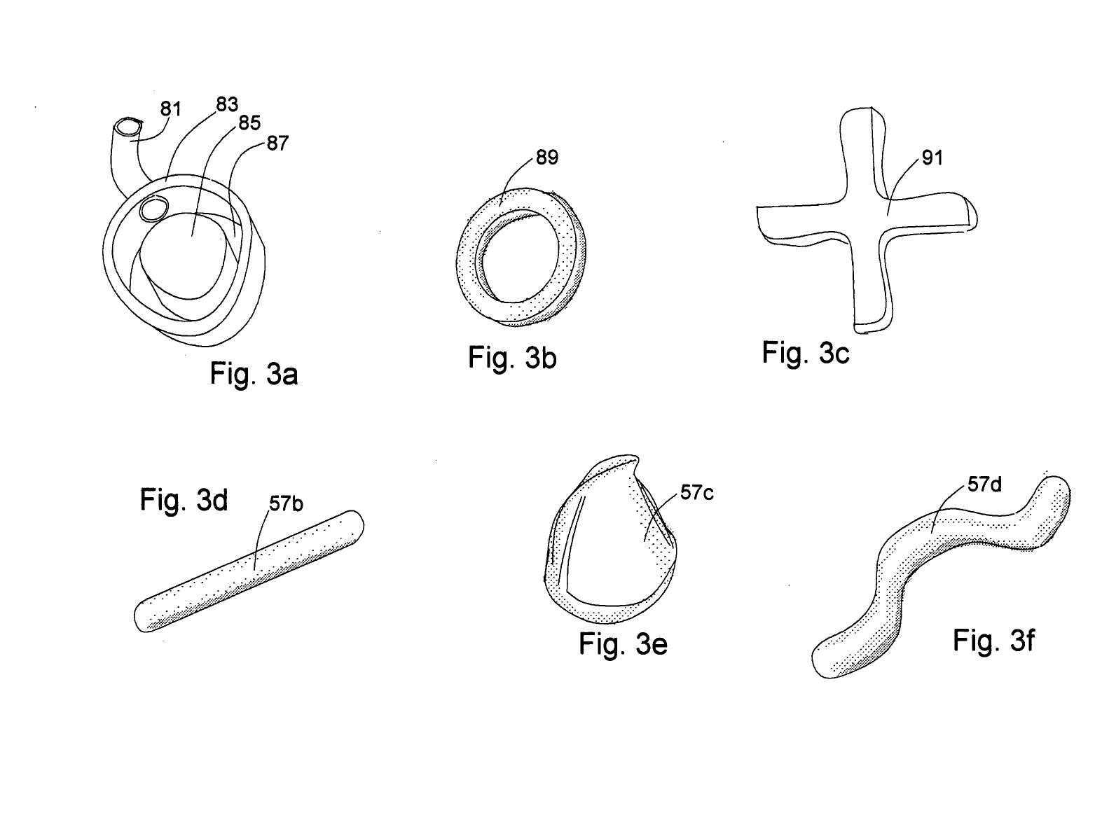

As above, for all products herein, liquid egg whites are whipped to a peaked quasi solid state. Three additive steps are described herein. A first ingredient additive step is adding ingredients prior to the whipping step. Liquefied gelatin is an example of an ingredient that can be added to liquid egg white wherein the liquid egg white with the gelatin will still whip into the peaked quasi solid state. It is noted that many ingredients in volumes such as those described herein when added to the liquid egg white will prevent the liquid egg white from transforming to a peaked quasi solid state. The liquid egg white with additional ingredients will instead remain primarily as a liquid when mixed with a whipping whisk. A second ingredient additive step is to add ingredients after the liquid egg white is whipped but before it is cooked. As above we added egg white protein, whey protein, cheese, salt, coloring, and oil during the additive step and also experimented with a variety of other ingredients. It is noted that many ingredients in volumes such as those described herein when added to the whipped egg white and mixed in will cause the whipped liquid egg white to transform from a peaked quasi solid state back to a liquid state. To minimize this effect, generally, mixing into whipped egg should generally be thorough but brief and non-vigorous. As in FIG. 3C, a third additive step is to spray on additives onto the surface of the collet after extrusion either prior to cooking it, midway through cooking it, and/or after cooking it. We produced cheese flavored whipped collet extrusions by spraying on a yellow cheese slurry after the first cooking step but before the microwave step and produced tasty orange cheese puffs resembling those of Cheetos brand made from corn meal. An alternate is to tumble on additives (either spray or powder) once the exterior of the collet has been solidified through cooking or water removal.

It should be noted that the Jay Rob egg white protein product includes lecithin which is therefore incorporated herein as an ingredient.

FIG. 2C is an ingredient additive step wherein cheese flavoring and coloring are sprayed onto the surface of a cooked collet while the collet is on the baking sheet. As above, once the collet is solidified it can be tumbled while ingredients are added to its surface.

Notes about additives include; when mixing in cheese flavoring (including salt therein) into the whipped egg, the mixing process must be very brief and not vigorous or the whipped egg with transform back to a liquid. Similarly, when mixing oil such as canola into the whipped egg the mixing process must be very brief and not vigorous or the whipped egg with transform back to a liquid. Alternately a water based cheese, salt, and yellow coloring can be sprayed onto the extrusions just before they are placed in the microwave. If this is done, the microwave cooking time is doubled and the second convention oven cooking time is doubled. Similarly, an oil such as canola oil can be sprayed onto the extrusions just before they are placed in the microwave. If this is done, the microwave cooking time is doubled and the second convention oven cooking time is doubled.

For the purpose of comparing collet ingredients of the present invention to ingredients of corn meal collets of the prior art, the product herein always has egg white as an ingredient which is generally between 20% and 100% of the solids in the final product.

FIG. 2a illustrates an oiling the cookware step. In this manufacturing step, an oil deposition apparatus 25a sprays cooking oil 24 onto the surface of the cookware 23. Canola oil is suitable and flavor ingredients can be added as desired. Programmable ingredient deposition sprayer assemblies suitable for this purpose are available from commercial food manufacturing equipment suppliers. They have programmable pumps and valves that open and close at timed intervals to deposit a desired amount of fluid onto a targeted surface within a defined amount of time.

FIG. 2b illustrates extrusion deposition of whipped raw egg batter to produce a crunchy egg collet puff product discussed above. The puffed egg product takes advantage of the changes that raw eggs undergo when whipped. The ingredient mixing module 27 whips ingredients in the proportions described above. After whipping, the raw egg batter is heavily aerated and clings to an upside down spoon, the whipping essentially mixes air as an ingredient into the batter. A raw egg extrusion deposition apparatus 29c deposits the whipped batter onto the cookware 23 as a raw egg extrusion 57. The raw egg extrusion deposition apparatus 29c including (as previously discussed) valves and pumps that are computer programmable and an extrusion orifice 30 through which raw egg batter exits and is deposited as approximately one inch diameter three inch long light any cylinders onto the cookware 23 which after cooking as described above will comprise the crunchy whipped egg collet 57b crunchy half inch diameter cylinders.

One part dried powdered egg white and 8 parts of water can be substituted for liquid egg whites. A 1 cup mixture of this was whipped to a foam in the mixer and added were ½ teaspoon gelatin, ½ teaspoon of Jel Dessert powder from Nutra Drink Co, 1 tablespoon Agar Agar which is nearly 100% dietary fiber, and 1 tablespoon of canola oil. This mixture was continuously whipped and stayed as a peaked foam. It cooked to be a very light airy crisp. When 1 tablespoon of cheese powder with salt was added to the foam it quickly lost its foam properties and whisked down to a liquid. Gelatin, Jel Dessert powder from Nutra Drink Co, Agar Agar, copper, and potassium bitartrate are examples of whipped egg white foam additives that stabilize the foam.

Due to the egg whipping process, for products described herein air volume comprises 25% or greater of final product volume. Using liquid displacement, this can be measured by measuring the volume displaced by a finished whipped collet product and then crushing that product to a fine powder and measuring the volume displaced by the resulting powder. The powder volume will be 25% or less volume compared to the finished whipped collet product volume. If the liquid used to measure volume displacement is water, one sprays the collet with oil before immersing in water to seal the collet and prevent water from entering. Other means of measuring volume change in the collet versus the crushed collet powder are known.

The crunchy egg puff product receives the additive step of FIG. 2c to add salt, oil, flavoring or coloring to be a partially cooked whipped egg collet with additives 57a. Alternately, the cooked egg puffs may be tumbled in a bath of dry flavorings such as dried cheese that is common in puffed snack foods. Alternately, the puffed raw egg can first be solidified then sprinkled with cheese flavoring additives, then microwaved to crispness. In any case, the final product, a cheese flavored egg puff is generally over 20% egg by volume.

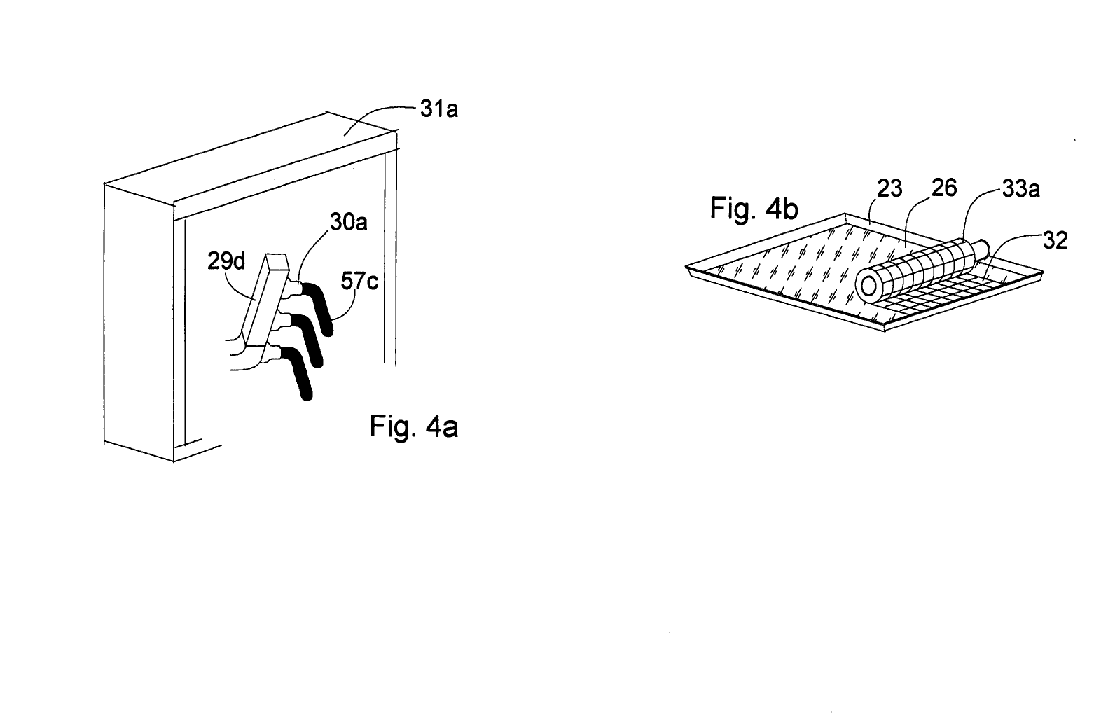

The brittle texture of the puffed egg product described from FIG. 4b is characterized under a Three Pont Bend test. A final product moisture content of less than 15% percent is achieved and can vary between 0% and 15% moisture by volume or weight.

FIG. 2c illustrates an additive step. An additive application apparatus 35a is similar to the oil deposition apparatus 25a of FIG. 2a with the programmable pumps and valves programmed to open and close at timed intervals to deposit a desired amount of fluid onto the targeted surface within a defined amount of time. In this step, an additive 34 such as canola cooking oil, salt; cheese, onion, garlic, water, and/or orange coloring is sprayed onto the egg collet product work in progress.

A programmable moisture sensor such as from MoistureTech.com can be added to any step during the manufacturing process to ensure moisture meets targeted standards.

While the ideal crunchiness is achieve at approximately two percent moisture content, in practice the final product has some variability between zero percent and fifteen percent moisture content by weight or by volume.

The puffed crunchy egg product contains a high volume of air; for the purpose of measuring ingredient content percentages by volume, air content is not considered.

A finished crunchy egg collet extrusion is easily held by a human hand as is common with nearly all crunchy snack foods currently consumed by consumers. Multiple product units (individual collets) are packaged together in a bag similar to corn meal extruded collets currently available to consumers. They are similarly easily grasped and consumed with one hand. Consumers often eat snack foods while doing other things such as driving a vehicle, using electronic devices, or watching TV. Such products need to be easily manipulated and consumable in bite sized pieces such as is possible with the finished crunchy egg collet described herein.

To illustrate the crunchy aspect of the extruded whipped egg collet described herein, a final product texture test is administered. Food Technology Corporation supplies the Three Point Bend test apparatus illustrated in parent applications referenced herein. It and similar products are widely used to study a product's crunchiness and other texture attributes. Bend profile, audible sound, and water content are three characteristics that can be used to compare the present crunchy whipped egg collet product with prior art crunchy products such as corn meal collets, potato chips, corn tortilla chips, wheat crackers and wheat based cookies. Bend profile, audible sound, and water content are three characteristics that can be used to contrast the present crunchy egg product with prior art baked and fried products containing egg. The finished crunchy whipped egg collet fractures and crushes suddenly with a measurable sound and with minimal angular bend. The current product is similar to prior art corn meal collets in that when fractured it produces an audible “crack” sound. Additionally, the current product is similar to prior art corn meal collets in that its brittle nature allows for less than a ten degree angular bend before a fracture appears. The Three Point Bend test contrasts the prior art high egg composition products that do not fracture at less than a ten degree angular bend. The Three Point Bend test contrasts the prior art high egg composition products that do not produce an audible crack sound when fractured under angular stress or crushing pressure. Depending upon manufacturing quality controls, some product variability can occur whereby an angular bend up to ten degrees may be demonstrated before fracture in the Three Point Bend test. The current product is contrasted with prior art egg based products that have a moisture content of greater than 15%.

The product is ready for packaging and distribution using processes common in the salty snack food category.

FIG. 3a illustrates an onion ring shaping mold. The mold includes a raw egg batter input tube 81, an outer wall 83, an inner wall 85, and a ejection surface 87. In operation, raw egg batter enters the mold, fills the mold, and is then pushed out of the mold by the ejection surface 87 to be deposited onto a cooking surface to be cooked as described above. Alternately, the mold is over filled with batter and a cutter (not shown) repeatedly cuts “O” shaped raw egg batter that falls to be deposited onto a cooking surface. Alternately the raw egg batter can be fully cooked or partially cooked within the mold and the ejected from the mold by mechanical movement of the ejection surface 87. In any case the gap between the inner wall and the outer wall comprises an orifice through which “O” shaped whipped egg extrusions exit. A high protein onion flavored ring 89 comprises an “O” shaped whipped egg extrusion cooked according the processes described herein wherein onion powder, garlic powder, and salt are substituted for cheese in the “Egg Puff plus protein plus cheese” recipe to comprise a “Egg Puff plus protein plus onion flavoring” crunchy whipped egg extrusion product which is very light, airy, crunchy, and tasty. The “O” shaped onion flavored ring product having an internal circular wall and an external circular wall similar to the mold orifice shape.

FIG. 3c illustrates an alternate high protein crunchy product shape. Using similar apparatus an processes, a shaping mold or extrusion nozzle orifice shape, an alternate extrusion shape 91 can take many forms such as the cross shape depicted and many other forms.

FIG. 3d illustrates a final elongated whipped egg cullet product ready to eat. The crunchy whipped egg cullet 57b is manufactured as described above. It is a long cylindrical extrusion and comprises a high protein low carb crunchy product similar in low moisture, brittleness, crunch, size, taste, texture, packaging, and shelf life to those commonly produced in the salty snack food industry.

FIG. 3e illustrates a dot shaped whipped egg cullet product ready to eat. A crunchy whipped egg cullet dot 57c is produced by depositing a circular extrusion dot onto the cooking surface and completing the same steps as described above. It has a smaller from factor but is otherwise the same as the long cylindrical extrusions and comprises a high protein low carb crunchy product similar in low moisture, brittleness, crunch, size, taste, texture, packaging, and shelf life to those commonly produced in the salty snack food industry.

FIG. 3f illustrates a curly shaped whipped egg cullet product ready to eat. A crunchy whipped egg cullet curl 57d is produced by moving the extrusion orifice 30 back and forth laterally during the deposition process described above during deposition of raw egg batter onto the cooking surface and completed the same steps as described above. It is a curl shaped cylindrical extrusions and comprises a high protein low carb crunchy product similar in low moisture, brittleness, crunch, size, taste, texture, packaging, and shelf life to those commonly produced in the salty snack food industry.

FIG. 4a illustrates a whipped egg extrusion and cooking process where the better begins cooking before deposition onto a cooking surface. An alternate cooking module 31a step comprises a convection oven or a microwave cooking environment wherein an alternate extruder 29d with an alternate extrusion orifice 30a extrudes raw egg batter 57c into the air. The raw egg batter begins and may complete the cooking process before it is deposited onto a surface. Once the extrusions reach a length where the extrusion can no longer support itself, it breaks at that length.

FIG. 4b illustrates a batter sheeting, cooking, and cutting process to produce whipped egg crunchy snack products. Batter is first sheeted (poured or extruded onto a cooking surface) and then undergoes the steps of cooking and cutting. A sheeted batter 26 is first partially or fully cooked, and is then cut into desired shapes by a cutter 33a to form crunchy whipped egg products 32 that comprise a high protein low carb crunchy product similar in low moisture, brittleness, crunch, size, taste, texture, packaging, and shelf life to those commonly produced in the salty snack food industry.

### Alternate Embodiment

Two tablespoons of Casein powder were mixed with ½ teaspoon of a foaming such as gelatin and/or agar agar in 1 cup of water and then whipped to a foam using a KitchenAid mixer in the test kitchen. This produce a good stable foam after 5 minutes of whipping. This foam did not contain any egg ingredient and can be substituted for the whipped egg in the above formulae and processes to produce a non-egg crunchy product.

### Operation of the Invention

Operation of the invention has been discussed under the above under the Detailed Description of the Invention heading and is not repeated here to avoid redundancy.

### CONCLUSION, RAMIFICATIONS, AND SCOPE

Thus the reader will see that the crunchy whipped egg collet product, formulae, manufacturing apparatus, and manufacturing processes of this invention provides a well defined and desirable consumer product that is nutritious and fulfills a gap in a crunchy high protein low carbohydrate snack food product category. While the above description describes many specifications, these should not be construed as limitations on the scope of the invention, but rather as an exemplification of a preferred embodiment thereof. Many other variations are possible.

The egg ingredient herein can comprise whole egg, liquid egg white, powdered egg white, egg white protein, or any egg product derived there from including glucose reduced dried egg, glucose reduced dried egg white for example.

It should be noted that the phrase “raw egg batter” is used herein to distinguish between the batter, solidified egg, and crisped egg. In fact the egg portion of the batter may consist of only dried egg or dried egg white in which case no literal raw egg is utilized.

Raw egg extrusion or deposition or batter extrusion or deposition means placing the batter into a position for cooking for example; depositing batter onto a surface, extruding batter onto a surface, depositing batter into a fryer, extruding batter into a fryer, and extruding batter into air that is then heated or microwaved. Alternately, the batter can be pumped into a mold and cooked within the mold. Extrusions exit and orifice and generally maintain the shape of the orifice through the remainder of the manufacturing process.

The term solidifying is used herein to mean transitioning of the batter from a quasi liquid or foam state to a high moisture content solid state, solidifying is a cooking process.

The term crisping is used here to mean transitioning of the solidified egg into a low moisture crunchy product. Crisping is a cooking process and/or a drying process.

Ingredients are mixed together herein, whipping is a specialized form of mixing that may for example mean mixing air or other gases into the raw egg or the batter to achieve certain properties suitable for the crunchy puffed egg product for example. Egg proteins comprise hydrophobic ends and hydrophilic ends. During whipping, the proteins align such that the hydrophobic ends align with the air side of a bubble, and the hydrophilic ends align with the water side of an air bubble. This makes the bubbles stable through the cooking process. Foaming agents and foaming stabilizers can be added to increase the foaming and stability properties; Gelatin, Jel Dessert powder from Nutra Drink Co, Agar Agar, copper, and potassium bitartrate are examples.

Spraying additives onto the solidified egg is described as a color, flavoring, texture, or oil additive step. Other additive steps are possible such as sprinkling onto the solidified egg, and tumbling the solidified egg in a bath of dried or moist flavorings. Similarly the batter can receive additives through spraying, sprinkling, and tumbling and the crisped egg can receive additives through spraying, sprinkling, and tumbling.

Microwaving, baking, and frying can be substituted for one another.

References are made herein to cooking processes, and drying processes. It is understood that the ingredients and processes herein can be adapted to work with alternate cooking apparatuses such as tunnel microwave oven (using electromagnetic energy), tunnel RF oven (using electromagnetic energy), tunnel oven (using thermal energy), tunnel convection oven (using thermal energy), tunnel dryer, commercial fryer (using thermal energy), etc.

Water plus dry egg white at a ratio of 8 parts water to 1 part dried egg white can be substituted for liquid egg white.

Whey protein, casein, dry buttermilk, dry milk, milk, cheese flavoring, and other combinations of whole milk or derivatives of milk all comprise a dairy ingredient that can be utilized herein to modify protein, flavor, and foaming properties.

Gelatin, and Guar Gum are hydrocolloids often used as thickening agents in food recipes. Alternate hydrocolloids and/or thicken agents may be substituted. Those with high protein to carb ratio such as gelatin are ideal.

Agar Agar is very high in dietary fiber and is an additive herein to increase dietary fiber. Alternate dietary fiber additives may be substituted. Those with high protein to carb ratios and low in sugars are ideal.

The terms “batter” and dough can be used interchangeably to mean uncooked ingredients.

What is claimed:

1) A crunchy egg product comprising;
egg,
wherein said egg undergoes a cooking process,
wherein by volume said final crunchy egg product contains more than thirty percent egg,
wherein by weight said final crunchy egg product contains less than ten percent water wherein said crunchy egg product has a crunchy attribute that is characterized by one selected from the group consisting of when said crunchy egg product is fractured an audible cracking sound is produced, and when said crunchy egg product is subjected to a three point bend test it fractures after bending ten degrees or less.

2) The crunchy egg product of claim 1 wherein said, when said crunchy egg product is fractured an audible cracking sound is produced, attribute is selected and wherein when said crunchy egg product is subjected to a three point bend test it fractures after bending ten degrees or less.

3) The crunchy egg product of claim 1 wherein a single unit of said crunchy egg product is suitable in size for grasping and holding with fingers during consumption.

4) The crunchy egg product of claim 1 wherein prior to cooking said egg comprises a water reduced egg product.

5) The crunchy egg product of claim 1 wherein prior to cooking said egg comprises dried egg.

6) The crunchy egg product of claim 1 wherein said crunchy egg product further comprises at least one ingredient selected from the group consisting of whole egg, egg white, dried egg, dried egg white, water, air, coloring, onion, garlic, salt, pepper, cheese, taco flavoring, barbecue flavoring, milk, oil, fat, shortening, yeast, and baking power.

7) The crunchy egg product of claim 6 wherein said ingredient is added at a time selected from the group consisting of added to be part of a mixture prior to cooking, added after a solidification step, and added after a crisping step.

8) The crunchy egg product of claim 6 wherein said ingredient is incorporated into the product by a process selected from the group consisting of mixing, whipping, spraying, sprinkling, and tumbling.

9) The crunchy egg product of claim 1 wherein said cooking process comprises one selected from the group consisting of microwaving, frying, and baking.

10) The crunchy egg product of claim 1 wherein a drying process is performed and in a sequence selected from the group consisting of said cooking process is first performed then said drying process, said drying process is first performed then said cooking process, and said cooking and said drying processes are performed concurrently.

11) The crunchy egg product of claim 1 wherein said product first undergoes a solidification step, then a cutting step, then a drying step.

12) The crunchy egg product of claim 1 wherein prior to cooking said egg is extruded to produce a desired product shape characteristic.

13) The crunchy egg product of claim 1 wherein said cooking occurs in a mold to produce a desired product shape characteristic.

14) The crunchy egg product of claim 1 wherein prior to cooking said egg is poured to produce a desired product shape characteristic.

15) The crunchy egg product of claim 1 wherein its manufacturing process comprises the steps of;
Providing cookware,
Oiling said cookware,
Deposition of ingredients onto cookware,
Solidification,
Cutting,
and drying.

16) The crunchy egg product of claim 1 wherein a fracture consists of one selected from the group consisting of a crack that penetrates through the thickness of said product, and a crack that penetrates the surface of said product.
